(19) United States
(12) Patent Application Publication
(10) Pub. No.: US 2024/0075659 A1
(43) Pub. Date: Mar. 7, 2024

(54) MODABLE POLYMER MATERIAL CONTAINING RECYCLED AUTOMOTIVE SHREDDER RESIDUE (ASR) AND METHOD OF MANUFACTURE

(71) Applicant: Louis Padnos Iron and Metal Company, Holland, MI (US)

(72) Inventors: Gary Barnett, Angola, IN (US); Erik Jepsen, Grand Haven, MI (US); Lisa Purcell, West Olive, MI (US); Martin Przekadziniski, Hudsonville, MI (US); Robert Herweyer, Fennville, MI (US); Jason Bergsma, Wyoming, MI (US)

(73) Assignee: Louis Padnos Iron and Metal Company, Holland, MI (US)

(21) Appl. No.: 18/242,957

(22) Filed: Sep. 6, 2023

Related U.S. Application Data
(60) Provisional application No. 63/404,356, filed on Sep. 7, 2022.

(51) Int. Cl. B29C 39/00; B29C 39/02

(52) U.S. Cl. CPC B29C 39/003; B29C 39/026; B29K 2101/12

(57) ABSTRACT

Moldable material comprising at least 5% by weight of polymeric regrind material recovered from Automotive Shredder Residue (ASR) and method of manufacturing the same are provided. The method comprises the steps of providing a polymer material sorted from ASR; grinding the polymer material sorted from ASR to form a regrind material; depositing the regrind material into a liquid solution having a specific gravity and performing a liquid density separation; removing a plurality of pieces of regrind material having a specific gravity of less than the liquid solution specific gravity from a surface of the liquid; conditioning the removed pieces of regrind material; blending the respective pieces of regrind material with a primary polymer to create a polymeric blend; compounding the polymeric blend via the addition of at least one additive thereby creating a plastics compound; and supplying the resultant plastics compound to an extrusion machine to produce the moldable material.

### CROSS-REFERENCE TO RELATED APPLICATIONS

This application claims priority to U.S. Provisional Patent Application No. 63/404,356 filed on Sep. 7, 2022 and entitled MOLDABLE POLYMER MATERIAL CONTAINING RECYCLED AUTOMOTIVE SHREDDER RESIDUE (ASR) AND METHOD OF MANUFACTURE which is hereby incorporated by reference.

### TECHNICAL FIELD

The disclosure relates generally to a moldable polymer material comprising recycled ASR (Automotive Shredder Residue) and a method of manufacturing the same.

### BACKGROUND

All kinds of materials are used in manufacturing consumer goods such as household appliances and automobiles. These materials include ferrous metals, e.g., iron and steel, non-ferrous metals, e.g., stainless steel, aluminum, and copper, and other non-metallic materials, such as, e.g., plastic, rubber, insulation, and cloth. This conglomeration of materials presents an interesting challenge in the recycling process-namely separating the constituent materials as completely as possible for subsequent resale and downstream use in further manufacture. Improved separation of the materials results in scrap that is more useful and therefore has higher value. Accordingly, there is a constant desire for improved material separation following the shredding of post-consumer materials.

In the automobile and household appliance recycling process, for example, scrapped articles are generally transferred to junkyards, where recyclable parts, hazardous liquids such as fuel and oil, and tires are collected. Engines and transmissions made of metal materials are typically disassembled for recycling. Residual bodies are likely transferred to a shredding facility to undergo processes such as crushing, grinding, magnetic separation, whirling separation, and screen separation.

During the above shredding and sortation procedures, valuable metals such as ferrous metals and non-ferrous metals are recovered and sorted. Other residues, such as plastics, rubber, glass, and fiber that are generated during the above processes may also be recovered. The entirety of the recovered residue is called Automotive Shredder Residue (ASR). The techniques for making these basic ferrous metals, non-ferrous metals, and non-metal material separations and sortations are well known.

However, after the separation of the ferrous and non-ferrous metals, the remaining non-metal Automotive Shredder Residue (ASR), still contains usable non-metal materials. For example, approximately 20% of such non-metal ASR contains usable non-metal materials that may be recycled or re-used in further manufacture of sustainable materials. At present, such non-metal Automotive Shredder Residue (ASR) materials currently end up largely in landfills. As such, there exists a need for a solution that improves the recycling process of waste polymer material derived from post-consumer sources, such that this additional non-metal Automotive Shredder Residue (ASR) may be reclaimed for use and incorporation in further manufacture of sustainable products.

### SUMMARY

A moldable material comprising at least 5% by weight of polymer regrind material recovered from Automotive Shredder Residue (ASR) and a method of manufacturing the same are provided. The moldable material comprises a primary polymer that is a virgin thermoplastic material and a secondary polymer that is a recycled or reclaimed thermoplastic material. Together the primary polymer and the secondary polymer form a polymer material blend. The primary polymer comprises up to 95% by weight of a polymer material blend. The secondary polymer comprises at least 5% by weight of the polymer material blend. In one example, the secondary polymer is a regrind polymer material recovered from waste plastic material derived from post-consumer sources, namely from non-metal Automotive Shredder Residue (ASR). The moldable material is from about 7% to about 20% filled with at least one additive and comprises a Mass Flow Index (MFI) of from about 5 to about 30 g/10 min.

The moldable material may be formed or otherwise manufactured via the present method. The present method is initiated following the processing of raw materials, e.g., residual automobile bodies, household appliances, etc., e.g., the crushing, grinding, magnetic separation, whirling separation, and screen separation. During such shredding and sortation processing, valuable metals such as ferrous metals and non-ferrous metals are recovered. The remaining residues, such as plastics, rubber, glass, and fiber that are generated during the aforementioned processes, are defined herein as non-metal Automobile Shredder Residue (ASR).

Once the non-metal Automotive Shredder Residue (ASR) is obtained or recovered, and the polymeric material of the same is selected and sorted therefrom, the present method of manufacture comprises the following steps: providing polymeric material selected and sorted from an Automotive Shredder Residue (ASR); grinding the polymeric material selected and sorted from the Automotive Shredder Residue (ASR) via a grinding process to form a polymeric regrind material; depositing the polymeric regrind material into a liquid solution having a liquid solution specific gravity and performing a liquid density separation; extracting a plurality of pieces of polymer regrind material with a specific gravity of less than the liquid solution specific gravity from a surface of the liquid solution; conditioning the plurality of pieces of polymer regrind material extracted from the surface of the liquid solution; blending the polymer regrind material with a primary polymer to form a polymeric blend; compounding the polymeric blend via the addition of at least one additive thereby creating a plastics compound; supplying the plastics compound to an extrusion machine to produce the moldable material comprising the Automotive Shredder Residue (ASR); cooling the extruded moldable material; pelletizing the extruded moldable material into a plurality of polymer pellets having predetermined pellet shape; drying the plurality of polymer pellets; and deodorizing the plurality of polymer pellets.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The operation of the invention may be better understood by reference to the detailed description taken in connection with the following illustrations, wherein:

FIG. 1A is a schematic plan view of an example shredding system.

FIG. 1B is a schematic elevation view of the example shredding system.

FIG. 1C is a schematic enlarged view of an infeed conveyor.

FIG. 1D is a schematic enlarged view of a post-consumer product exiting the infeed conveyor and entering a hammermill.

FIG. 1E is a schematic enlarged cross-sectional view of a plurality of feed rolls and the hammermill with internal rotor.

FIG. 1F is a schematic enlarged elevation view of an example magnetic separator having at least one drum magnet.

FIG. 1G is a schematic view of example exit conveyors for the ferrous materials and non-ferrous materials following processing of the shredder material in the magnetic separator.

FIG. 2A is a schematic plan view of an example sortation system for sorting non-ferrous metals and non-metal Automotive Shredder Residue (ASR).

FIG. 2B is a schematic elevation view of the example sortation system for sorting non-ferrous metals and non-metal Automotive Shredder Residue (ASR).

FIG. 2C is a schematic enlarged view of a trommel screen.

FIG. 2D is a schematic enlarged view of an eddy current separator.

FIG. 2E is a schematic enlarged elevation view of a portion of an example induction sorter, wherein the at least one finger is in a first position.

FIG. 2F is a schematic enlarged elevation view of a portion of the example induction sorter, wherein the at least one finger is in a second position.

FIG. 3A is a schematic elevation view of an example granulator or polymer grinding machine.

FIG. 3B is a schematic elevation view of an example float tank and a conditioning apparatus for washing, rinsing, and drying the plurality of pieces of polymer regrind material.

FIG. 3C is a schematic plan view of the example float tank and a conditioning apparatus for washing, rinsing, and drying the plurality of pieces of polymer regrind material.

FIG. 3D is a schematic elevation view of an example plastics processing machine for extrusion and pelletizing of the moldable material.

FIG. 3E is a schematic perspective view of an example drying and deodorizing apparatus for drying and deodorizing the plurality of pellets of the moldable material.

FIG. 4A illustrates flow diagram detailing the steps of the present method of manufacturing a moldable polymer material containing recycled non-metal Automotive Shredder Residue (ASR).

FIG. 4B illustrates a flow diagram further detailing Step 101 of the present method, namely, providing polymer material selected and sorted from an Automotive Shredder Residue (ASR).

### DETAILED DESCRIPTION

While the present disclosure may be described with respect to specific applications or industries, those skilled in the art will recognize the broader applicability of the disclosure. The terms “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second” are illustrative only and are not intended to limit the scope of the disclosure in any way.

The term “longitudinal”, as used throughout this detailed description and in the claims, refers to a direction extending a length of a component. In some cases, a component may be identified with a longitudinal axis as well as a forward and rearward longitudinal direction along that axis. The longitudinal direction or axis may also be referred to as an anterior-posterior direction or axis.

The term “transverse”, as used throughout this detailed description and in the claims, refers to a direction extending a width of a component. The transverse direction or axis may also be referred to as a lateral direction or axis or a mediolateral direction or axis.

The term “vertical”, as used throughout this detailed description and in the claims, refers to a direction generally perpendicular to both the lateral and longitudinal directions.

In addition, the term “proximal” refers to a direction that is nearer a center of a component. Likewise, the term “distal” refers to a relative position that is further away from a center of the component. Thus, the terms proximal and distal may be understood to provide generally opposing terms to describe relative spatial positions.

Referring to the drawings, wherein like reference numerals refer to like components throughout the several views a moldable material containing recycled ASR (Automotive Shredder Residue) and a method of manufacturing 100 the same are provided. In a general sense, a moldable material comprising at least 5% by weight of polymeric regrind material recovered from waste plastic material derived from post-consumer sources, namely post-consumer material recovered from Automotive Shredder Residue (ASR) and a method of manufacturing the same are provided.

More particularly, the moldable material may be manufactured in multiple grades, for example, a first-grade plastic compound, which is suitable for use in the manufacture of automobile structural parts, such as kickboards, dashboards, interior cover panels, A-pillars, and the like, and a second-grade plastic compound, which is suitable for use in the manufacture of containers for household items and the like.

The moldable material may be formed or otherwise manufactured via the present method 100, which is initiated following the processing of raw materials, e.g., residual automobile bodies, household appliances, etc. During such processing, valuable metals such as ferrous metals and nonferrous metals are recovered, the remaining residues, such as plastics, rubber, glass, and fiber that are generated during the aforementioned processes, are defined herein as non-metal Automobile Shredder Residue (ASR). Following the recovery of the non-metal Automotive Shredder Residue (ASR) and the sortation of the polymeric material therefrom, the polymeric material selected and sorted from the non-metal Automotive Shredder Residue (ASR) is provided and undergoes a grinding process, a liquid density separation, a blending process, a compounding process, an extrusion process, and pelletizing.

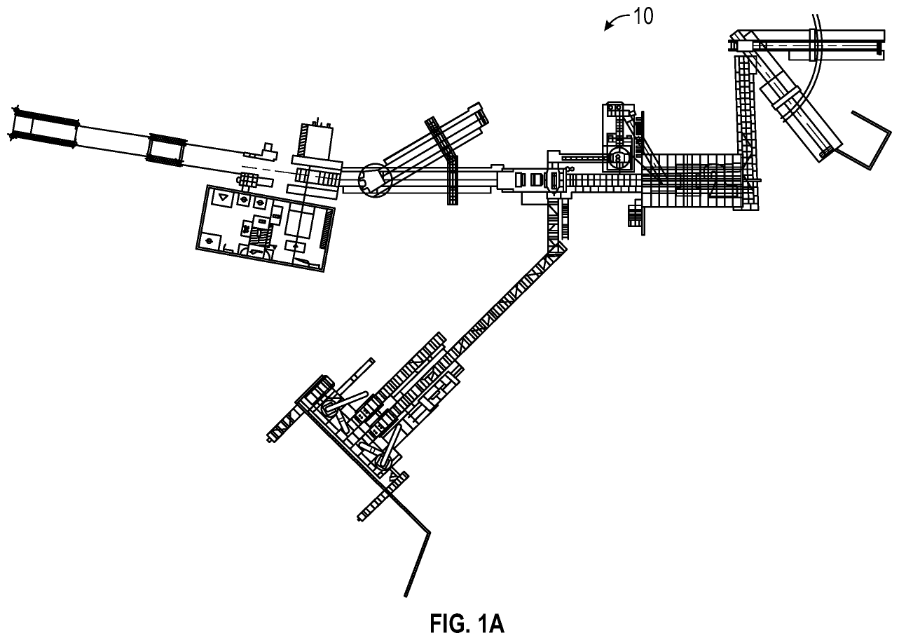

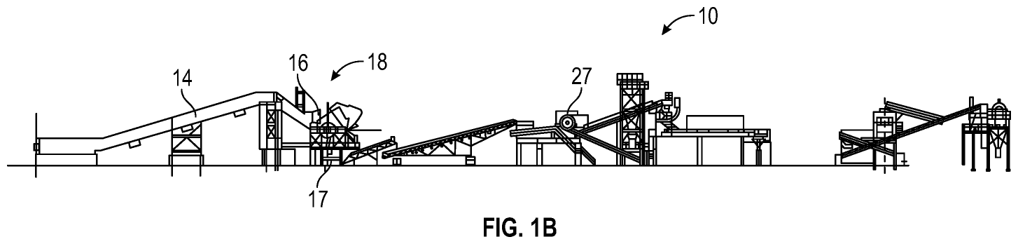

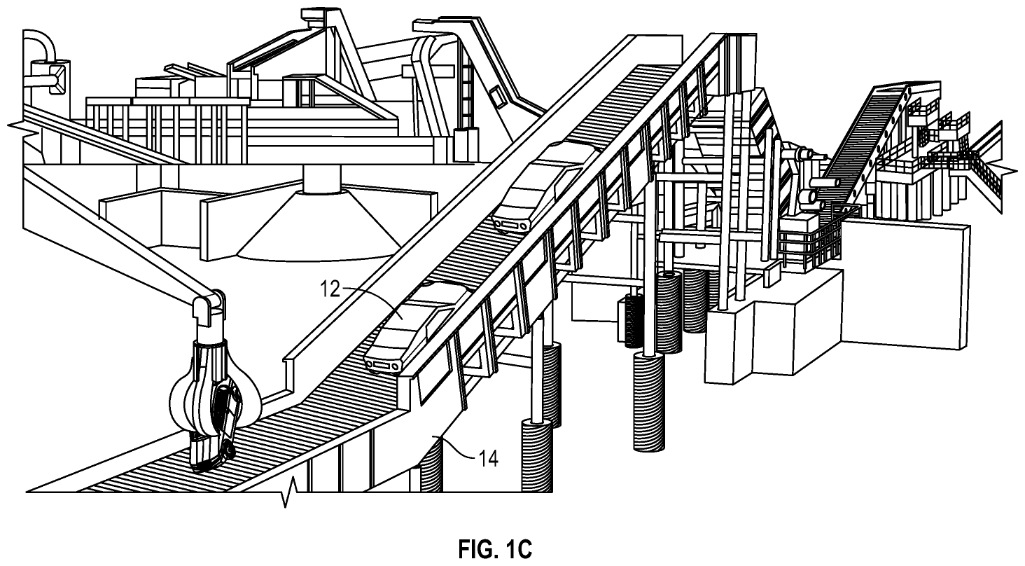

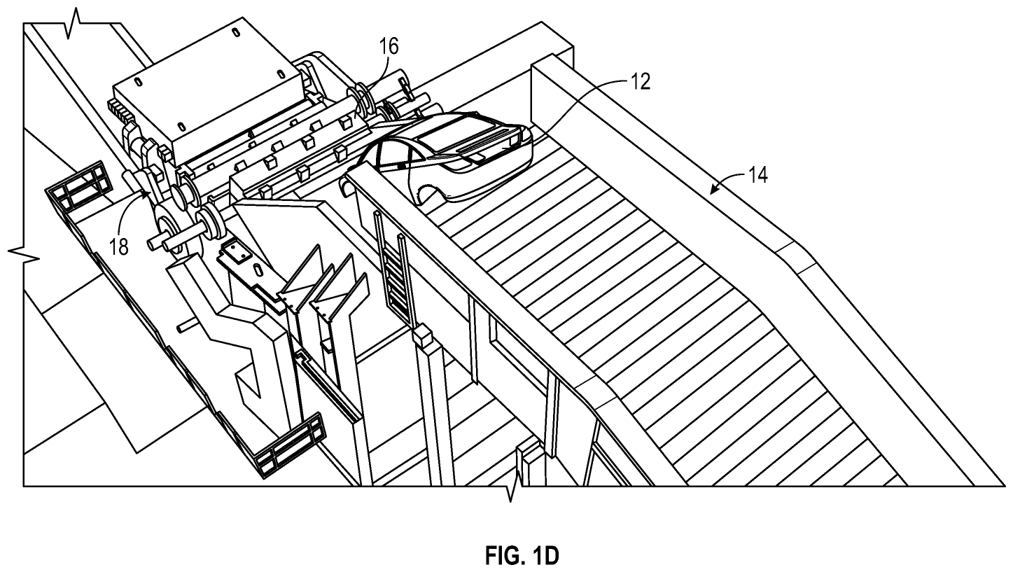

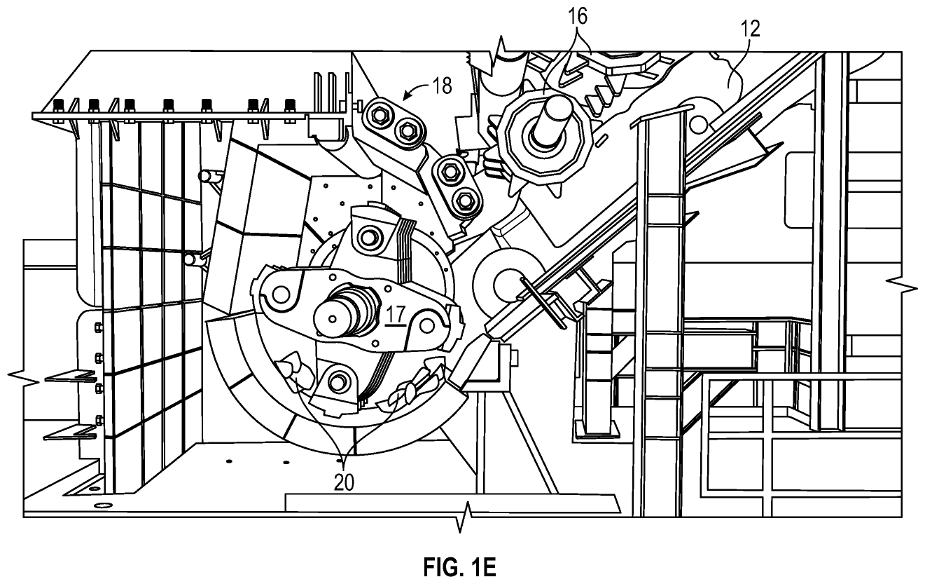

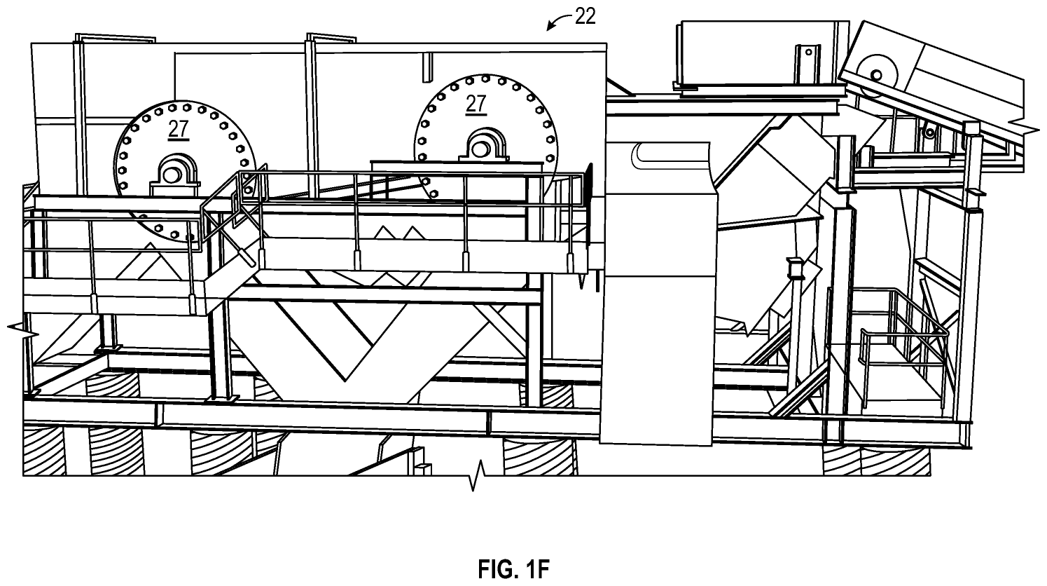

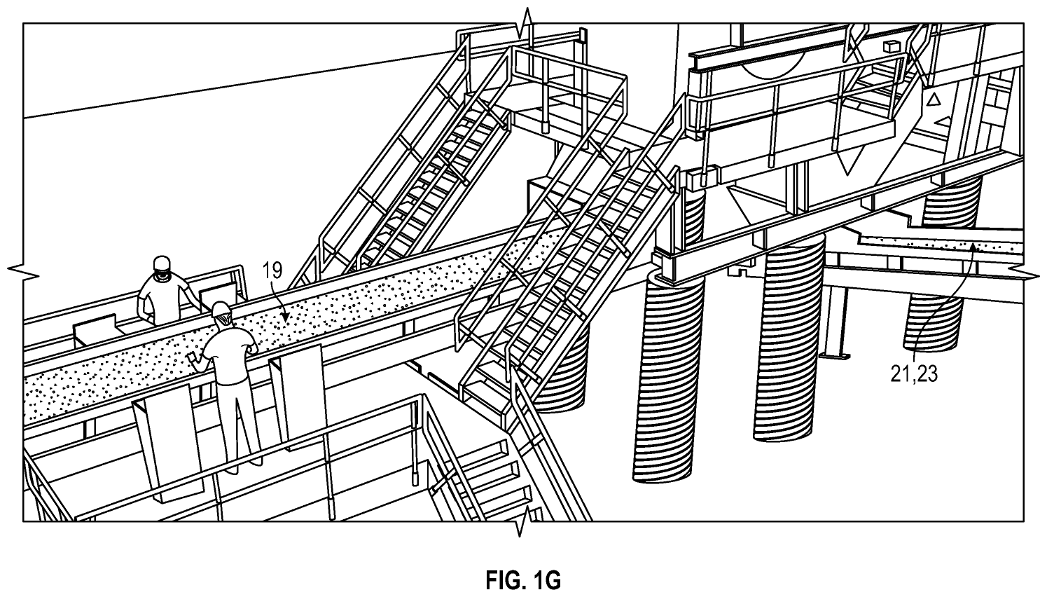

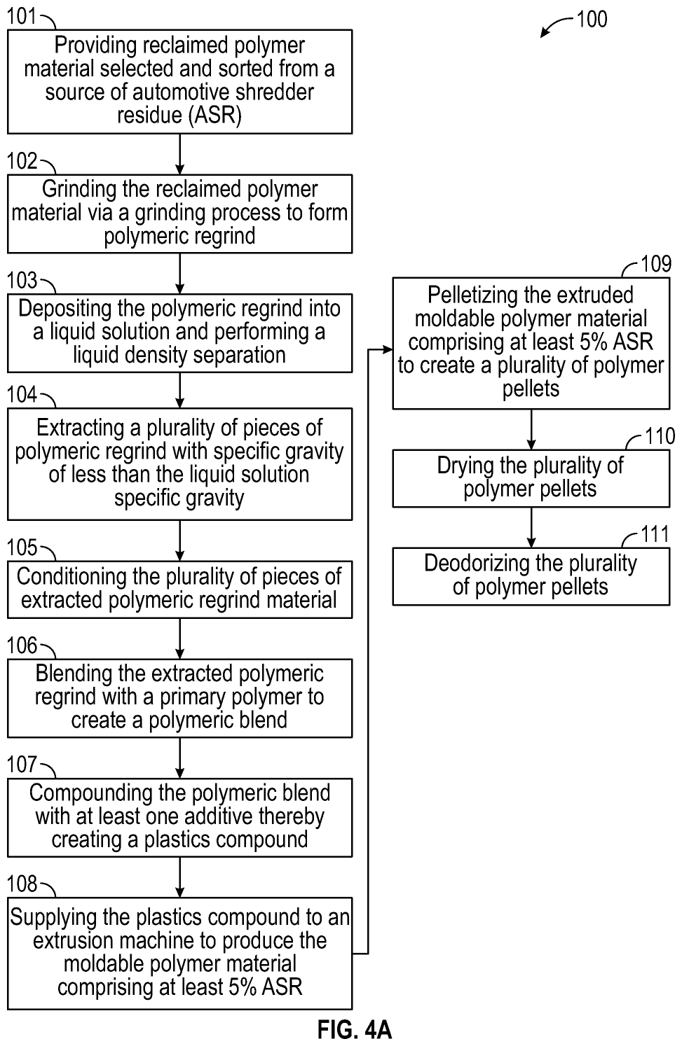

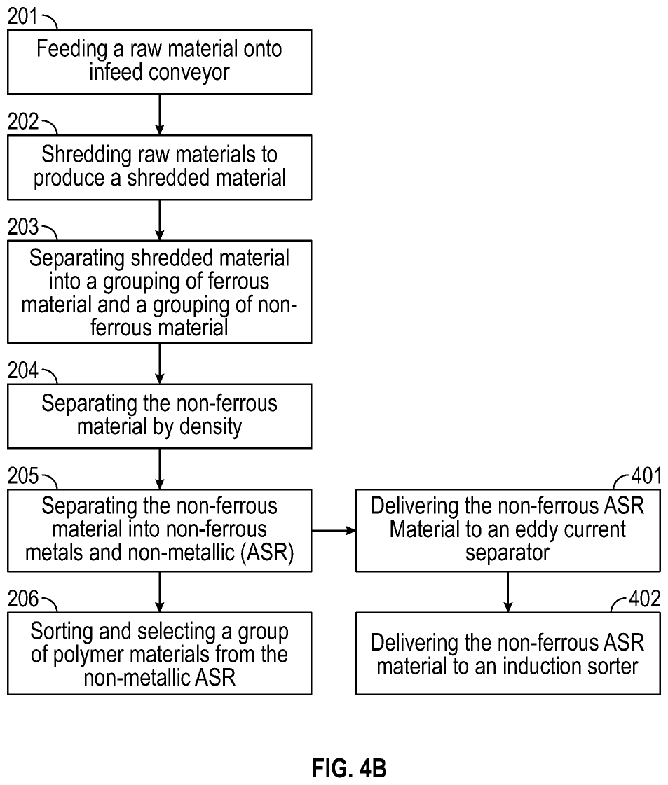

Referring to FIGS. 1A-1E, a sample shredding and sortation system 10 is detailed. The sample shredding and sortation system 10 is utilized in the completion of method step 101, i.e., providing reclaimed polymer material selected and sorted from a source of Automotive Shredder Residue (ASR). Method step 101 is further defined in FIG. 4B via sub-steps 201-206.

Namely, at sub-step 201, raw shredder materials 12, such as but not limited to automobiles, trucks, buses, household appliances, e.g., washers, dryers, refrigerators, and sheet metal, scraps, and waste metal may be fed into a shredding and sortation system 10 via an infeed conveyor 14. The infeed conveyor 14 delivers the raw shredder materials 12 to a system of feed rolls 16 and a hammermill 18 having at least one rotor 17 capable of crushing the shredder materials 12 into discrete pieces of shredded material 20.

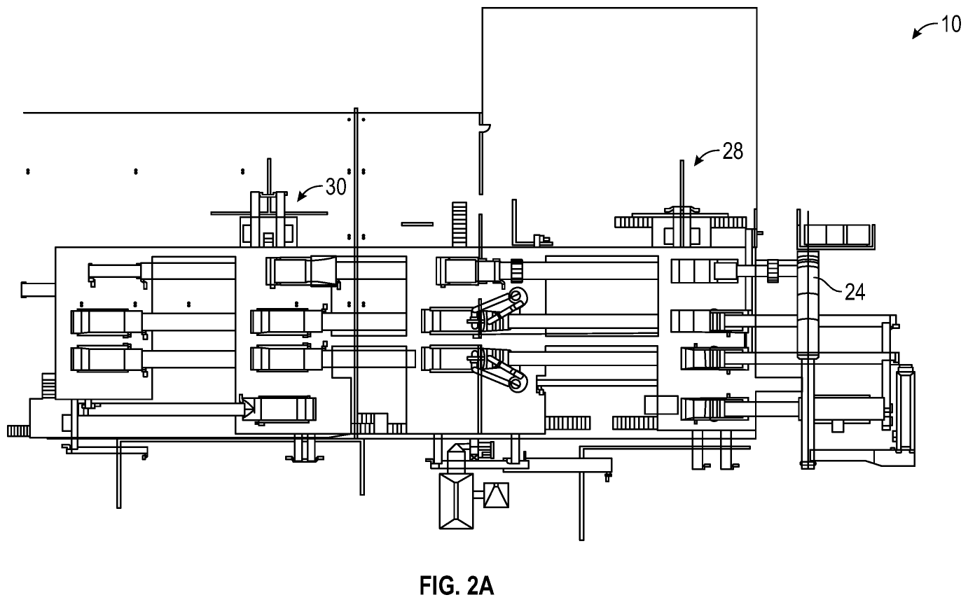

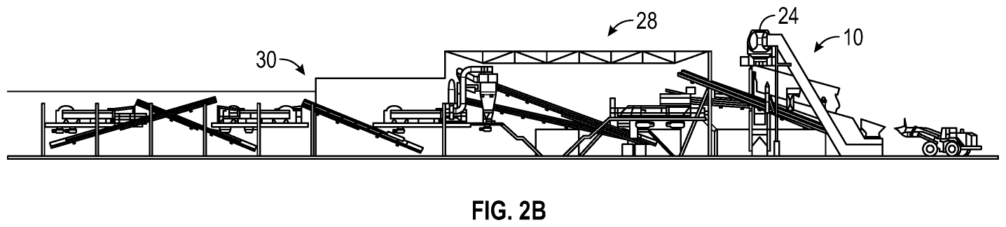

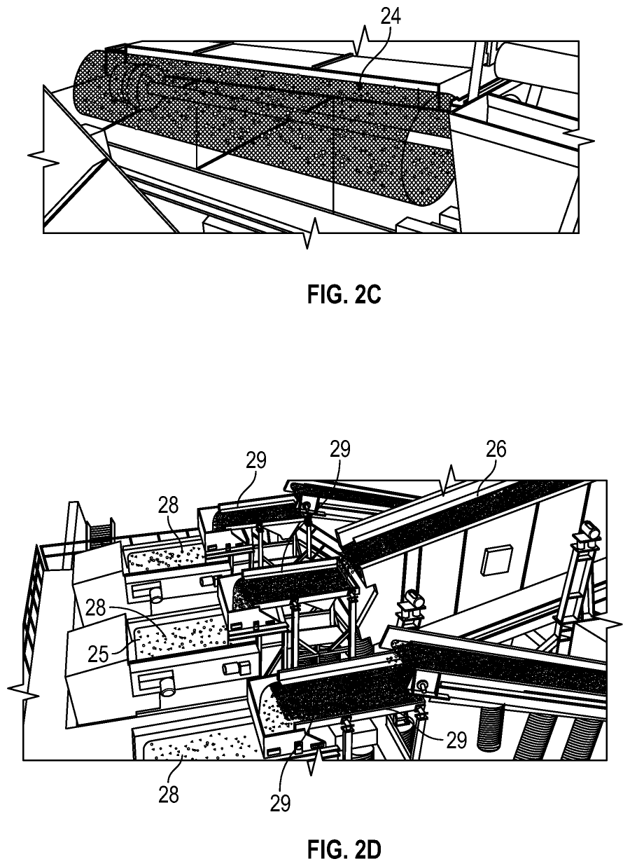

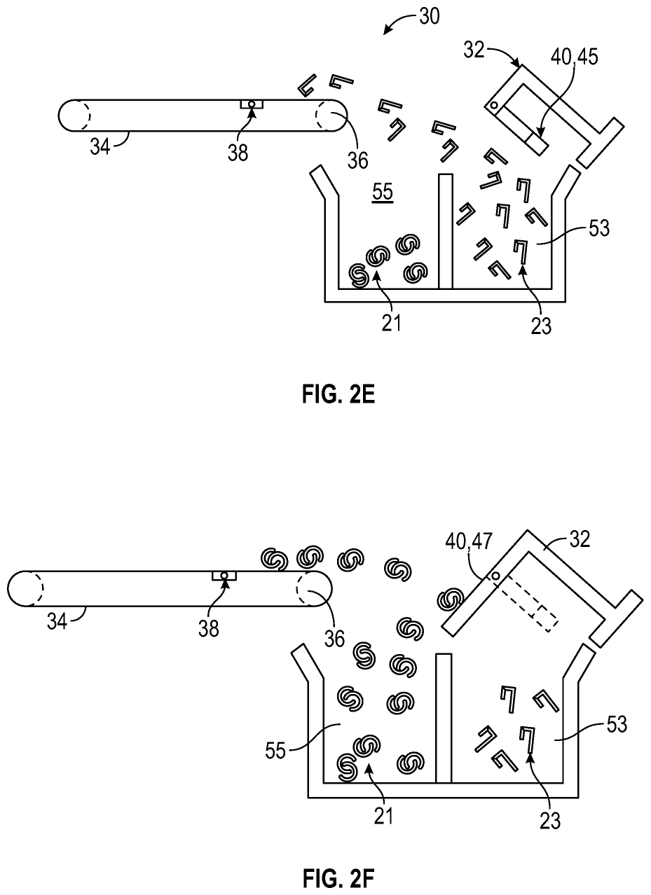

At sub-step 202, the raw shredder materials 12 are shredded at the hammermill 18 to produce the plurality of discrete pieces of shredder material 20. Such shredder material 20 may be removed from the hammermill 18 and conveyed, via a system of additional conveyors, to a plurality of sortation devices 22, 24, 26, 28, 30 configured to separate and sort the shredder material 20 into groupings of ferrous metals, non-ferrous metals, and non-metal Automotive Shredder Residue (ASR), e.g., other residues, such as plastics, rubber, glass, and fiber that are generated during the shredding process, as illustrated in FIGS. 1F-2F and method sub steps 203-205.

To initiate the sortation process, at sub-step 203, a grouping of ferrous metal shredder materials 19 may be separated from the non-ferrous shredder materials 21, 23 with a magnetic sorter 22 (FIG. 1F). The magnetic sorter 22 may be a powerful magnet, a plurality of magnets, a large magnetic roller, or the like. In one example, the magnetic sorter 22 may comprise one or more of drum magnets 27. The magnetic sorter 22 may be responsive to the shredder material 20 and generate the sortation of the shredder material 20 into a collection of ferrous metals 19 and a collection of non-ferrous material (non-ferrous metals 21 and non-metal shredder material 23). Such ferrous metals 19 may be stacked via a radial stacker or the like, in a discrete location and recycled and reused in subsequent applications, for example, provided to a downstream foundry consumer for use in further manufacture.

As shown in FIGS. 2A-2B, the leftover shredder material 20, is a separate collection of non-ferrous material (non-ferrous metals 21 and non-metal shredder material 23). The non-ferrous metals 21, such as stainless steel, copper, brass, zinc, aluminum, lead, and the like, along with the non-metal shredder material 23, such as plastics, rubber, wood, glass, rocks, dirt, paper, film, textiles, and other metals may be subject to further sortation and separation.

As illustrated at step 204, the non-ferrous material 21, 23 may be further subject to sortation by size, via at least one screen 24, or a similar sortation device (FIG. 2C). In one example, the screen 24 may be a planar mesh surface wherein items of a size larger than the screen grates are maintained above and upon the screen and items of a size smaller that the screen grates are allowed to pass therethrough. In another example, the screen 24 may be a trommel or rotary screen 24, such that the physical size separation of the non-ferrous material 21, 23 is achieved as the material spirals down the rotating drum, where the undersized material smaller than the screen apertures passes through the screen, while the oversized material exits at the other end of the drum. In some examples, the non-ferrous material 21, 23 may be subject to sortation via multiple screens. For example, the non-ferrous materials 21, 23 may be passed through a first screen and a subsequent second screen to further sort the non-ferrous material by size. The second screen or any subsequent screen thereafter in the sortation process may comprise a fines screen or the like 26.

Referring to FIGS. 2A-2F and sub-step 205 in FIG. 4B, the various size collections of the non-ferrous material 21, 23 may then be subject to further sortation and separation to separate non-ferrous metals 21 from non-metal Automotive Shredder Residue (ASR) material 23. In one example, as detailed in sub-step 401, non-ferrous metals 21 may be separated from the non-metal Automotive Shredder Residue (ASR) material 23 via delivery of the material 21, 23 to an eddy current separator 28 (FIG. 2D). The material may be fed to the eddy current separator 28 via a vibrating feeder 29 or another suitable delivery apparatus. The eddy current separator 28 further includes a rotor 27 positioned at the end of a belt 25. The rotor 27 may be lined on the exterior with magnets arranged with alternating poles, or the rotor may be an electromagnet. In this way, the non-ferrous metal materials 21 are caught up in the eddy current created by the rotating magnet. Said another way, the non-ferrous metals 21 are launched or repelled by the magnet and deposited into a first product container or on receiving belt. The non-metal Automotive Shredder Residue (ASR) material 23 fails to interact with the magnet and simply falls of off the belt 25 due to gravity and into a second product container or onto another receiving belt.

As detailed in sub-step 402, in addition to the eddy current separator 28, an induction sorter 30 may act upon the non-ferrous material 21, 23 following the eddy current separator 28 in order to capture any remaining non-ferrous metals 21 that may remain unseparated or sorted from the non-metal Automotive Shredder Residue (ASR) material 23. As shown in FIGS. 2E and 2F, the induction sorter 30 may comprise a conveyor 34 having an exit end 36, a plurality of sensors 38 arranged transversely with respect to the conveyor 34, and an induction assembly 32 disposed at the exit end 36 of the conveyor 34. The induction assembly 32 may comprise a plurality of fingers 40, actuatable between a first position 45 and a second position 47, each associated with one of the plurality of sensors 38.

In this way, non-ferrous material 21, 23 disposed upon the conveyor 34, follows a predetermined trajectory upon being discharged from the exit end 36 of the conveyor 34, and this predetermined trajectory is a function of at least the speed of the conveyor 34. If a respective piece of non-ferrous metal material is detected on the conveyor 34 as it passes a respective sensor 38, the respective sensor 38 generates a detection signal and transmits the detection signal to a control unit 44.

The control unit 44 may include a non-transitory computer readable medium. The term non-transitory computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read, as well as networked versions of the same. The non-transitory computer readable medium stores or has written or embodied thereon a set of computer executable instructions that govern the actuation of the plurality of fingers 40 between the first position 45 and the second position 47 based on received detection signals from the plurality of sensors 38.

Upon receipt of a detection signal from one of the plurality of sensors 38, the control unit 44 is configured to actuate the respective finger 40 associated with the respective sensor 38 from a first position 45 (outside of the predetermined trajectory) to a second position 47 (within the predetermined trajectory) in order to contact the respective piece of detected non-ferrous metal material 21 and alter the trajectory of the same, such that the contacted piece of metal material 21 is directed to another metal material container or conveyor 55 that is different than the material container or conveyor 53 that receives the non-metal material 23 that follows the unaltered predetermined trajectory (FIGS. 2E and 2F).

The remaining material mixture, after the majority of metals have been recovered from shredder material 20, is defined herein as non-metal Automotive Shredder Residue (ASR) 23. While the non-metal Automotive Shredder Residue (ASR) material 23, may contain plastics, rubber, wood, glass, rocks, dirt, paper, film, textiles, etc., the predominant single material therein is often plastics, which can compose from about 15% to about 90% of the non-metal Automotive Shredder Residue (ASR) 23. Such percentages may vary depending on the type of post-consumer material and the steps taken in the metal separation process.

This remaining non-metal Automotive Shredder Residue (ASR) material 23 contains usable non-metal materials. For example, approximately 20% of such non-metal Automotive Shredder Residue (ASR) 23 contains usable non-metal materials that may be recycled or re-used in further manufacture of sustainable materials. At present, such non-metal materials currently end up largely in landfills. As such, there exists a need for a solution that improves the recycling process for post-consumer waste, such that this additional non-metal Automotive Shredder Residue (ASR) 23 material may be reclaimed for use as reclaimed moldable polymer materials for incorporation in further manufacture of sustainable products.

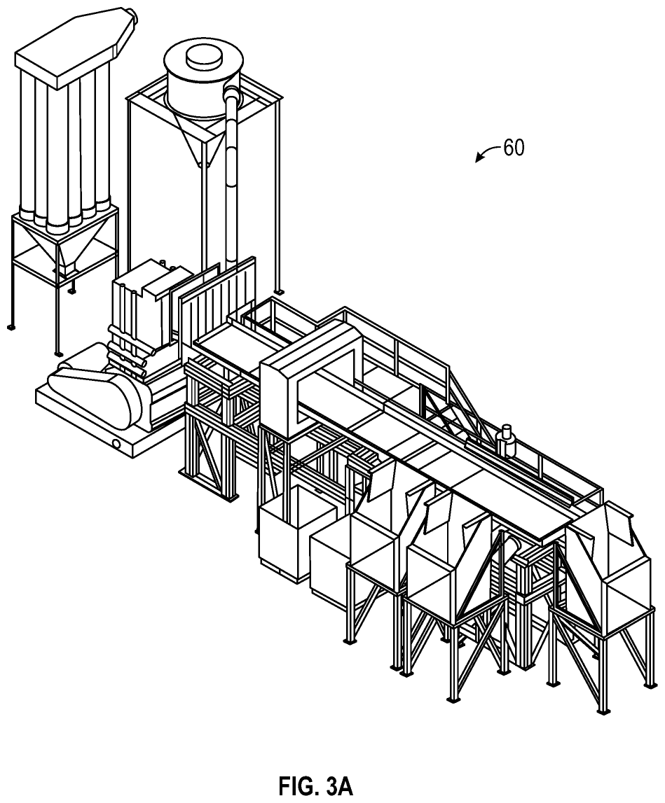

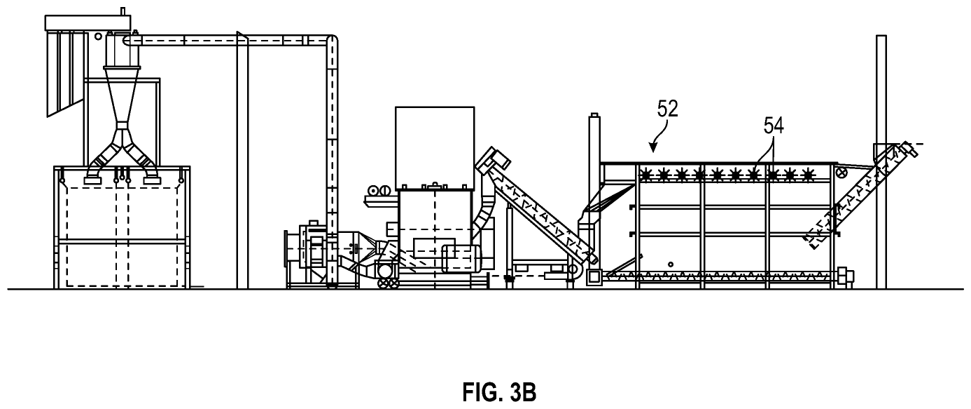

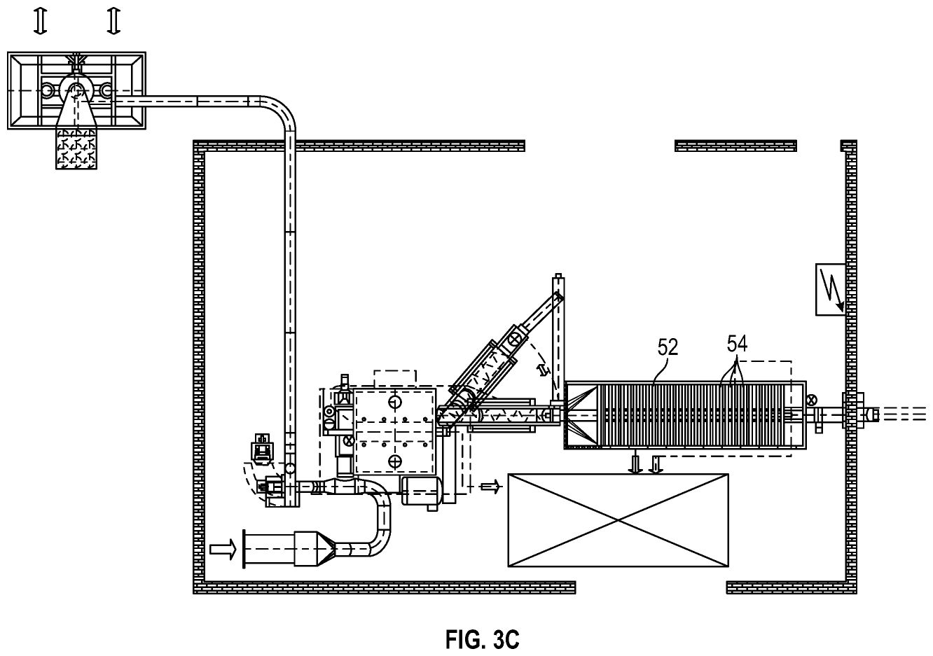

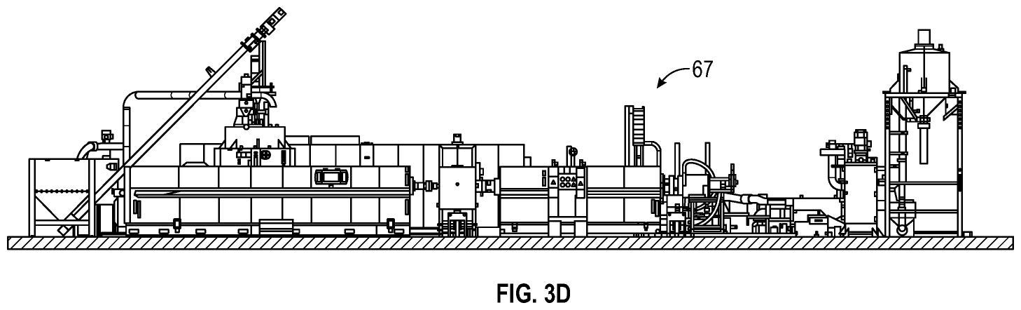

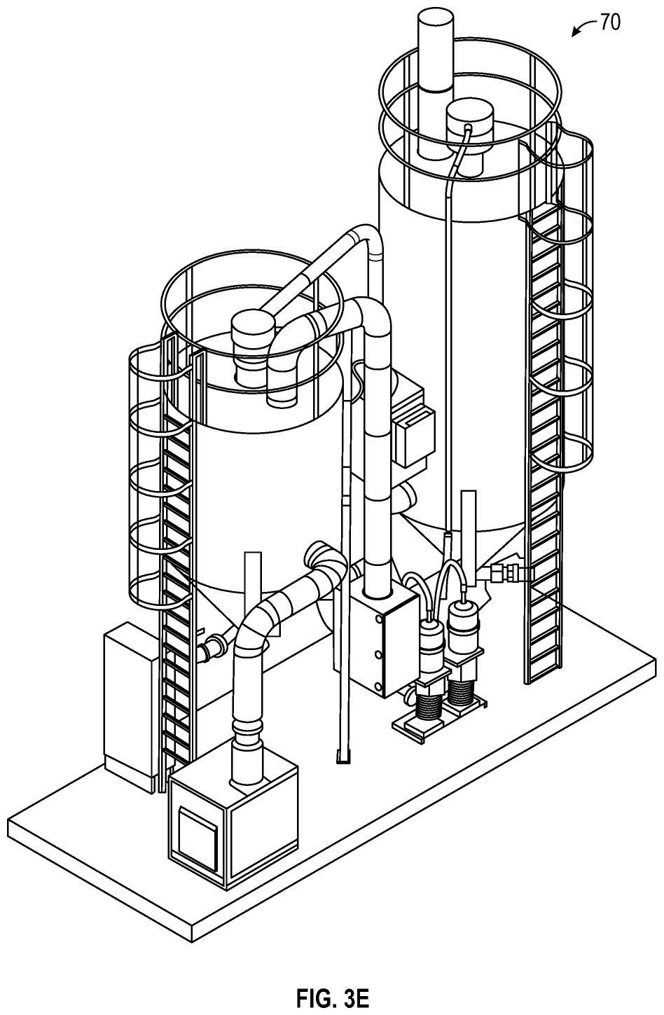

As illustrated in FIGS. 3A-3E, once the majority of metals are removed from the shredder material 20 via the upstream systems and processes 22, 24, 26, 28, 30, in method sub steps 201-205, the remaining non-metal Automotive Shredder Residue (ASR) material 23 may be further sorted such that the polymer or plastic materials are extracted from other non-metal materials such as aggregate, textiles, paper etc. in sub-step 206. In one example, this initial separation can be done via a number of processes including, but not limited to, delivery of the non-metal Automotive Shredder Residue (ASR) 23 to an air sortation system that may separate the material by size, weight, and/or density by directing a targeted burst of high velocity air at the respective pieces of material. The non-metal Automotive Shredder Residue (ASR) material 23 may be further selected and sorted by mechanical sorting means, electronic sorting means, or hand picking by line operators. The selection and sortation of polymer materials from the non-metal Automotive Shredder Residue (ASR) materials 23 completes the sub-steps of the method step 101, namely providing reclaimed polymer material selected and sorted form a source of Automotive Shredder Residue (ASR).

Referring back to FIG. 4A, following the selection and sortation of the non-metal Automotive Shredder Residue (ASR) materials 23, the selected polymer materials may, at step 102, undergo a grinding process, via grinding machine or granulator 60 (FIG. 3A), to form a polymeric regrind material having a predetermined maximum size. Source plastic or polymer that is optionally cut or ground to form smaller particles for processing is commonly known as regrind. The polymeric regrind material obtained from Automotive Shredder Residue (ASR) may be utilized in various applications, including, but not limited to, chemical recycling. Chemical recycling processes, such as pyrolysis and depolymerization, can break down the plastic components of the Automotive Shredder Residue (ASR) into their original monomers or other valuable chemical compounds for use in the production of new plastics. As such, the predetermined maximum size of the regrind is selected for convenience, to achieve appropriate melting properties when the regrind is processed, or in light of the reaction parameters. Such regrind product may be a saleable recycled material of its own, valuable to downstream consumers and material processors.

As illustrated in FIGS. 3B-3C, following the grinding process, at step 103, polymeric regrind material not sold as a recyclable material of its own, may be deposited into a liquid solution for the purposes of performing a liquid density separation. The liquid solution may be contained within a float tank 52 or the like. The liquid solution may have a specific gravity of from about 0.90 to about 1.30.

The source of polymeric regrind material is a combination of multiple types of polymers (and potentially elastomers) having various material densities and specific gravities. In many instances, the materials with a high specific gravity (more dense than water or other aqueous solutions) will drop to the bottom of the float tank 52, e.g., elastomers, rubbers, thermoset materials, whereas the materials with a lower specific gravity (less dense than water or other aqueous solutions) will float, e.g., thermoplastics, Polyphenylene Ether (PPE). Polypropylene (PP), and thermoplastic Polyolefins (TPO).

The process of performing a liquid density separation may further comprise, at step 104 (FIG. 4A), extracting and reclaiming the pieces of polymeric regrind material that float in the respective liquid solution, i.e., the polymeric regrind particles that have a specific gravity of less than the liquid solution specific gravity, and separating, the pieces of polymeric regrind material that sink in the respective liquid solution, i.e., the polymeric regrind particles that have a specific gravity of greater than the liquid solution specific gravity. Furthermore, the pieces of polymeric regrind material that sink in the respective liquid solution may be retrieved and subsequently processed for use in various industrial and consumer applications. For example, the pieces of polymeric material that sink may undergo a contaminant removal process and/or may be pelletized into a plurality of pellets having predetermined pellet shape. The pellets can serve as a sustainable raw material source for injection molding, extrusion, and other manufacturing methods.

Extraction of the polymeric regrind material that floats in the respective liquid solution, i.e., the polymeric regrind particles that have a specific gravity of less than the liquid solution specific gravity, may be completed via a skimming-style process that collects the floating regrind fragments from the surface of the liquid solution. Such example skimming processes may utilize drum skimmers 54 (FIG. 3B) or another suitable skimming device for regrind extraction from the surface of the liquid solution. Extraction of the polymeric regrind material that sink in the respective liquid solution, i.e., the polymeric regrind particles that have a specific gravity of greater than the liquid solution specific gravity, may be completed via draining the float tank 52 of the respective solution and reclaiming the polymeric material that sink to the bottom thereof.

In some examples, the extracted polymeric regrind material that floats in the respective liquid solution, i.e., the polymeric regrind particles that have a specific gravity of less than the liquid solution specific gravity, may be useful in creating multiple grades of blended polymer material. In one example, for a first-grade material, intended for use in further manufacture to create, for example, automotive cover panels, kickboards, dashboard, A-pillars, and the like, the polymeric regrind material may be deposited into a float tank 52 containing a liquid solution having a first solution specific gravity (step 103). The first solution specific gravity may be from about 0.90 to about 1.0. In this way, respective regrind particles of the polymeric regrind material having a specific gravity of less than the first solution specific gravity float to the top of the float tank and remain suspended on the surface of the liquid solution. These first-grade regrind granules may then be extracted (step 104) from the surface of the liquid solution via the skimmers 54 and transported or conveyed to a designated area or device for conditioning (step 105), i.e., washing, drying, and rinsing of the extracted first-grade regrind granules.

Once the first-grade regrind granules are extracted from the surface of the liquid solution, the solution may be altered, by adding water, such that the solution specific gravity is increased from the first solution specific gravity to a second solution specific gravity. The second solution specific gravity may be from about 1.0 to about 1.30. As the solution specific gravity increases to the second solution specific gravity, additional polymer regrind granules having a specific gravity greater than the first solution specific gravity but less than the second solution specific gravity, will begin to float to the surface of the liquid solution. These second-grade regrind granules, suitable for use in further manufacture of polymeric containers for household products, for example, may then be extracted from the surface of the liquid solution (step 104) via a skimming-style process that collects the floating regrind fragments from the surface of the liquid solution. Such example skimming processes may utilize drum skimmers 54 (FIG. 3B) or another suitable skimming device for regrind extraction from the surface of the liquid solution and conveyed or transported to another designated area or device for conditioning (step 105), i.e., washing, drying, and rinsing, of the extracted second-grade regrind granules. Once the second grade regrind granules are extracted from the surface of the liquid solution, the solution may be drained form the float tank 52 and the remaining sinking regrind granules, having a specific gravity greater than 1.30 may be collected from the bottom of the float tank 52. Such sinking regrind granules, having a specific gravity greater than 1.30, once retrieved may subsequently processed for use in various industrial and consumer applications, such as, a sustainable raw material source that does not undergo further manufacturing processes.

As shown in FIG. 3D, the conditioned first-grade regrind granules may then be blended (at step 106) with a primary polymer, for example a virgin polypropylene (PP) polymer in granule or resin form. Such blending may be conducted via depositing the first-grade regrind granules and the virgin polypropylene into a mixing machine at the desired percentages for the desired blend. In this way, the first-grade polymer blend is a blend of virgin and recycled materials. Such examples could include at least 5% by weight of the recycled materials (non-metal Automotive Shredder Residue (ASR) 23) with the remainder of the polymer (up to 95% by weight) being a virgin material e.g., polypropylene. In one particular example embodiment, the first-grade polymer blend may include at least 25% by weight of the recycled materials (non-metal Automotive Shredder Residue (ASR) 23) with the remainder of the polymer (up to 75% by weight) being a virgin material e.g., polypropylene.

The first-grade polymer blend may then be compounded via the addition of one or more additives, at step 107. In one example, the first-grade polymer blend may be compounded such that the resultant plastics compound is about 20% talc filled. Talc-filled polypropylenes exhibit improved rigidity, hardness, and heat resistance compared to base resins. In another example, the first-grade polymer blend may be compounded such that the resultant plastics compound is about 20% glass-filled. Glass-filled polypropylenes exhibit improved tensile strength compared to base resins. Such first-grade plastics compounds (ASR, virgin polypropylene, and filler) exhibit a Melt Flow Index (MFI) of from about 10 to about 25 g/10 min. In one preferred embodiment, the first-grade plastics compound exhibits an MFI of 20. An example method of measuring the melt index is provided in ASTM D1238, incorporated by reference in its entirety.

The conditioned (washed, dried, and rinsed) second-grade regrind granules may then be blended (step 106) with a primary polymer, for example a virgin polypropylene (PP) polymer resin. Such blending may be conducted via depositing the second-grade regrind granules and the virgin polypropylene into a mixing machine at the desired percentages for the desired blend. In this way, the second-grade polymer blend is a blend of virgin and recycled materials. Such examples could include at least 5% by weight of the recycled materials (non-metal Automotive Shredder Residue (ASR) 23) with the remainder of the blend (up to 95% by weight) being a virgin material e.g., polypropylene. In one particular example embodiment, the first-grade polymer blend may include at least 25% by weight of the recycled materials (non-metal Automotive Shredder Residue (ASR) 23) with the remainder of the polymer (up to 75% by weight) being a virgin material e.g., polypropylene.

The second-grade polymer blend may then be compounded via the addition of one or more additives, at step 107. In one example, the second-grade polymer blend may be compounded such that the resultant plastics compound is about 7% talc filled. Talc-filled polypropylenes exhibit improved rigidity, hardness, and heat resistance compared to base resins. In another example, the second-grade polymer blend may be compounded such that the resultant plastics compound is about 7% glass-filled. Glass-filled polypropylenes exhibit improved tensile strength compared to base resins. Such second-grade plastics compounds (non-metal ASR 23, virgin polypropylene, and filler) exhibits a Melt Flow Index (MFI) of from about 5 to about 30 g/10 min. In one preferred embodiment, the second-grade plastics compound exhibits an MFI of 10 g/10 min. An example method of measuring the melt index is provided in ASTM D1238, incorporated by reference in its entirety.

Other additives may be employed within the respective plastics compounds including, but not limited to, pigments, various stabilizers, flame retardants, wax, antioxidants, etc. For example, the addition of various plasticizers would increase the flexibility and durability of the final product as well as facilitate the processing of the material from a resinous form to a membrane or sheet. Still other additives or processing aids are optionally included such as mold release agents and lubricants, as are known in the art. It is understood that these additional non-filler additives will not significantly alter the desired Melt Flow Index (MFI). It is understood that combinations of the additives allow for customization of color and texture of the resultant moldable polymer material.

Following the compounding of the blended polymer material and the filler (step 107), the respective plastics compound is supplied to an extrusion machine, at step 108. The respective plastic compound once supplied to the extrusion machine is then heated and mechanically mixed until the plastics compound becomes a viscous fluid within the extrusion machine and is then subsequently forced through die via an extrusion screw. During extrusion, the mechanical process of forcing the polymeric material through the die has added effect to purge the material of contaminants. Moreover, the die defines the cross-sectional shape of the resultant moldable polymer material containing at least 5% Automotive Shredder Residue (ASR) by weight.

Example plastics processing machines 67, including mixing, blending, compounding, and extrusion capabilities, as illustrated by example in FIG. 3D are commercially available from manufacturers such as EREMA Plastics Recycling Systems and Starlinger Company.

The resultant moldable polymer material, containing at least 5% Automotive Shredder Residue (ASR) by weight, that exits the extruder through the die is cooled. Once cooled, the resultant moldable polymer material is pelletized into a plurality of pellets having predetermined pellet shape, at step 109. The predetermined pellet shape may maintain the same cross-sectional shape as the die. As such, the predetermined pellet shape may be customized for the purposes of branding, source origin recognition, and verification of the subject resultant moldable polymer material containing at least 5% Automotive Shredder Residue by weight.

Once pelletized, the plurality of polymer pellets may be dried, at step 110. Once dried, the plurality of polymer pellets may be deodorized (step 111) via a drying and deodorizing system 70, as shown by example in FIG. 3E, prior to shipment to the material consumer.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method of manufacturing a moldable polymer material comprising Automotive Shredder Reside (ASR), the method comprising the steps of:
providing reclaimed polymer material selected and sorted from a source of automotive shredder residue (ASR); and
grinding the reclaimed polymer material selected and sorted from the automotive shredder residue (ASR) via a grinding process to form a polymeric regrind material having a predetermined maximum size.

2. The method of manufacturing a moldable polymer material of claim 1, further comprising the steps of:
depositing the polymeric regrind material into a liquid solution having a liquid solution specific gravity of from about 0.90 to 1.30 and performing a liquid density separation; extracting a plurality of pieces of polymer regrind material with a specific gravity of less than the liquid solution from a surface of the liquid solution; and
conditioning the plurality of pieces of polymer regrind material extracted from the surface of the liquid solution, wherein conditioning the plurality of plurality of pieces of polymer regrind material is defined as at least one of washing, rinsing, and drying the plurality of plurality of pieces of polymer regrind material.

3. The method of manufacturing a moldable polymer material of claim 2, further comprising the steps of:
blending the polymer regrind material with a primary polymer resin to form a polymeric blend, wherein the polymer regrind material makes up at least 5% by weight of the polymeric blend;
compounding the polymeric blend with at least one additive thereby creating a plastics compound; and
supplying the plastics compound to an extrusion machine to produce the moldable polymer material comprising Automotive Shredder Residue (ASR).

4. The method of manufacturing a moldable polymer material of claim 3, further comprising the steps of pelletizing the extruded moldable polymer material comprising Automotive Shredder Residue (ASR) into a plurality of polymer pellets having predetermined pellet shape.

5. The method of manufacturing a moldable polymer material of claim 4, further comprising the steps of:
drying the plurality of polymer pellets; and
deodorizing the plurality of polymer pellets.

6. The method of manufacturing a moldable polymer material of claim 2 wherein the liquid solution has a first solution specific gravity of from about 0.90 to about 1.0, such that the respective pieces of polymer regrind material with a specific gravity lower than that of the first solution specific gravity float to a surface of the liquid solution.

7. The method of manufacturing a moldable polymer material of claim 6 wherein the plastics compound is a first-grade plastics compound, and wherein:
the polymeric blend is about 20% filled, such that the at least one additive comprises up to about 20% by weight of the polymeric blend; and
the first-grade plastics compound has a Melt Flow Index (MFI) of from about 10 to about 25 g/10 min.

8. The method of manufacturing a moldable polymer material of claim 6 wherein:
performing a liquid density separation further comprises the steps of:
altering the liquid solution with water, such that the liquid solution has a second solution specific gravity of from about 1.0 to about 1.30, such that the respective pieces of polymer regrind material with a specific gravity greater than that of the first liquid solution and less than that of the second solution float to the surface of the liquid solution; and
extracting the respective pieces of polymer regrind material with a specific gravity of greater than that of the first liquid solution and less than that of the second liquid solution from the surface of the altered liquid solution.

9. The method of manufacturing a moldable polymer material of claim 8 wherein:
the plastics compound is a second-grade plastics compound;
the polymeric blend is about 7% filled, such that the at least one additive comprises about 7% by weight of the polymeric blend; and
the second-grade plastics compound has a Melt Flow Index (MFI) of from about 5 to about 30 g/10 min.

10. The method of manufacturing a moldable polymer material of claim 9, further comprising the step of extracting a plurality of pieces of polymer regrind material with a specific gravity of greater than the liquid solution from the bottom surface of a float tank.

11. The method of manufacturing a moldable polymer material of claim 1 wherein providing polymer material selected and sorted from an automotive shredder residue (ASR) further comprises:
feeding a raw material onto an infeed conveyor;
shredding raw materials via a hammermill thereby producing a shredded material;
separating the shredded material into a ferrous material and a non-ferrous material via a plurality of magnets;
separating the non-ferrous material by density;
separating the non-ferrous material into non-ferrous metals and non-metallic automotive shredder residue (ASR); and
sorting and selecting a group of polymer materials from the non-metallic automotive shredder residue (ASR).

12. The method of manufacturing a moldable polymer material of claim 11 wherein separating the non-ferrous material by density further includes:
feeding the non-ferrous material through an air sortation system to separate the non-ferrous metals and non-metallic automotive shredder residue (ASR).

13. The method of manufacturing a moldable polymer material of claim 12 wherein separating the non-ferrous material into non-ferrous metals and non-metal automotive shredder residue (ASR) further includes the step of:
delivering the non-ferrous material to an eddy current separator such that the non-ferrous metals are separated from the non-metal automotive shredder residue (ASR).

14. The method of manufacturing a moldable polymer material of claim 13 wherein separating the non-ferrous material into non-ferrous metals and non-metal automotive shredder residue (ASR) further includes the step of: delivering the non-metal automotive shredder residue (ASR) to an induction sorting machine, wherein the induction sorting machine removes remaining non-ferrous metals from the non-metal automotive shredder residue.

15. A moldable material comprising:
a primary polymer that is a thermoplastic resin material that comprises is less than about 95% by weight of the polymer material blend;
a secondary polymer that is thermoplastic material and comprises at least 5% by weight of the polymer material blend; and
wherein the secondary polymer is regrind polymer material recovered from waste polymer material recovered from Automotive Shredder Residue (ASR).

16. The moldable material of claim 15 wherein:
the primary polymer comprises from about 70% to about 75% by weight of the polymer material blend; and
the secondary polymer comprises at least 25% by weight of the polymer material blend.

17. The moldable material of claim 16 wherein the moldable material is from about 7% to about 20% filled, such an at least one additive comprises from about 7% to about 20% by weight of a resultant plastics compound.

18. The moldable material of claim 17 wherein the resultant plastics compound is a first-grade plastics compound that has a Melt Flow Index (MFI) of from about 10 to about 25 g/10 min.

19. The moldable material of claim 18 wherein the at least one additive comprises about 20% by weight of the first-grade plastics compound and the first-grade plastics compound has a Melt Flow Index (MFI) of about 20 g/10 min.

20. The moldable material of claim 17 wherein the resultant plastics compound is a second-grade plastics compound and has a Melt Flow Index (MFI) of from about 5 to about 30 g/10 min.

21. The moldable material of claim 20 wherein the at least one additive comprises about 7% by weight of the second-grade plastics compound and the second-grade plastics compound has a Melt Flow Index (MFI) of about 10 g/10 min.
